(19) United States
(12) Patent Application Publication
(10) Pub. No.: US 2017/0113440 A1
(43) Pub. Date: Apr. 27, 2017

(54) LAMINATING THIN GLASS STRUCTURES

(71) Applicant: CORNING INCORPORATED, CORNING, NY (US)

(72) Inventors: Paul George Rickerl, Endicott, NY (US); Sarko Cherekdjian, Campbell, CA (US)

(21) Appl. No.: 15/316,993

(22) PCT Filed: Jun. 9, 2015
(86) PCT No.: PCT/US2015/034825

§ 371 Date: Dec. 7, 2016

Related U.S. Application Data
(60) Provisional application No. 62/011,305, filed on Jun. 12, 2014.

(51) Int. Cl. B32B 17/10; B32B 7/12; B32B 38/00; B32B 37/18; B32B 37/10; B32B 37/12; B32B 3/02; B32B 37/06

(52) U.S. Cl. CPC B32B 17/10293; B32B 3/02; B32B 7/12; B32B 17/10825; B32B 17/10871; B32B 17/10761; B32B 17/10788; B32B 17/1077; B32B 17/10036; B32B 37/06; B32B 37/18; B32B 37/1009; B32B 37/12; B32B 38/0012; B32B 2250/02; B32B 2255/26; B32B 2315/08; B32B 2605/006

(57) ABSTRACT

A method for finishing an edge of a glass laminate structure comprising the steps of assembling a glass laminate structure having a first glass sheet, a second glass sheet and an interlayer material intermediate the first and second glass sheets and placing a compressive material on a first edge of the assembled structure. A vacuum can be applied to a second edge of the assembled structure and the assembled structure heated to a predetermined temperature at or above a softening temperature of the interlayer material. The vacuum and temperature can be maintained for a predetermined period of time whereby the compressive material provides an in situ finish for the first edge of the glass laminate structure.

### CROSS-REFERENCE TO RELATED APPLICATIONS

This application claims the benefit of priority under 35 U.S.C. §119 of U.S. Provisional Application Ser. No. 62/011,305 filed on Jun. 12, 2014 the content of which is relied upon and incorporated herein by reference in its entirety.

### BACKGROUND

Glass laminate structures can be used as windows and glazings in architectural and vehicle or transportation applications, including automobiles, rolling stock, locomotives and airplanes. Glass laminate structures can also be used as glass panels in balustrades and stairs, and as decorative panels or covering for walls, columns, elevator cabs, appliances, electronic devices and other applications. Common types of glass laminate structures that are used in architectural and vehicular applications include clear and tinted glass laminate structures. As used herein, a glazing or a glass laminate structure (e.g., a glass laminate) can be a transparent, semi-transparent, translucent or opaque part of a window, panel, appliance, electronic device, wall or other structure having at least one glass sheet laminated to a polymeric layer, film or sheet. However, glass laminate structures may also be used as a cover glass on signs, electronic displays, electronic devices and appliances, as well as a host of other applications.

Automotive glazing, laminated architectural glass and other glass laminate structures typically include two sheets of 2 mm thick soda lime glass (heat treated or annealed) with a polyvinyl butyral (PVB) or other polymer interlayer intermediate the two sheets of soda lime glass. These glass laminate structures have certain advantages, including, low cost and a sufficient stiffness for automotive and other applications. However, because of their limited impact resistance, these laminate structures usually have a poor behavior and a higher probability of breakage when getting struck by roadside stones, vandals and other impact events.

Typical glass lamination processes for the architectural and automotive industries employ either vacuum bag or vacuum ring processes. In a typical vacuum bag process, the layers of the laminate structure are assembled in a stack, and the stack is wrapped in different films for lamination. There are release films to prevent stack/layers from sticking to the vacuum bag, breather films to facilitate vacuuming, and finally the vacuum bag to encase the sample in a vacuum environment for de-airing. In a typical vacuum ring process, a vacuum ring is used to seal the periphery of the stacked layers with a rubber ring seal which has a built in vacuum line for vacuuming. Both processes impose stress on the materials being laminated and subsequently create optical distortion and shape variations, especially when laminating thin glass sheets having thicknesses less than 2.0 mm. Thus, there is a need for an apparatus and process for laminating thin glass laminate structures with improved optical distortion and shape consistency. Further, there is a need for a process to provide improve edge finishing for glass laminate structures without an post-lamination grinding or finishing processes.

No admission is made that any reference cited herein constitutes prior art. Applicant expressly reserves the right to challenge the accuracy and pertinence of any cited documents.

### SUMMARY

Some embodiments of the present disclosure provide a method for finishing an edge of a glass laminate structure. The method includes assembling a glass laminate structure having a first glass sheet, a second glass sheet and an interlayer material intermediate the first and second glass sheets and placing a compressive material on a first edge of the assembled structure. The method also includes applying a vacuum to a second edge of the assembled structure and heating the assembled structure to a predetermined temperature at or above a softening temperature of the interlayer material. The method further includes maintaining the vacuum and temperature for a predetermined period of time whereby the compressive material provides an in situ finish for the first edge of the glass laminate structure. In some embodiments, the assembled structure is non-planar.

Further embodiments of the present disclosure provide a method for finishing an edge of a glass laminate structure. The method includes assembling a glass laminate structure having a first glass sheet, a second glass sheet and an interlayer material intermediate the first and second glass sheets and heating the assembled structure in an autoclave at a temperature at or above a softening temperature of the interlayer material. The method also includes maintaining the temperature for a predetermined period of time and performing an edge finish to one or more edges of the assembled structure during the steps of heating and maintaining.

Additional embodiments of the present disclosure provide a method for edge finishing a glass laminate structure. The method includes providing a glass laminate structure having a first glass sheet, a second glass sheet and an interlayer material intermediate the first and second glass sheets, heating the assembled structure in an autoclave at a temperature at or above a softening temperature of the interlayer material, and maintaining the temperature for a predetermined period of time. The method also includes the step of providing an edge finish to one or more edges of the assembled structure without cooling the autoclave.

Additional features and advantages of the claimed subject matter will be set forth in the detailed description which follows, and in part will be readily apparent to those skilled in the art from that description or recognized by practicing the claimed subject matter as described herein, including the detailed description which follows, the claims, as well as the appended drawings.

It is to be understood that both the foregoing general description and the following detailed description present embodiments of the present disclosure, and are intended to provide an overview or framework for understanding the nature and character of the claimed subject matter. The accompanying drawings are included to provide a further understanding of the present disclosure, and are incorporated into and constitute a part of this specification. The drawings illustrate various embodiments and together with the description serve to explain the principles and operations of the claimed subject matter.

### BRIEF DESCRIPTION OF THE DRAWINGS

For the purposes of illustration, there are forms shown in the drawings that are presently preferred, it being understood, however, that the embodiments disclosed and discussed herein are not limited to the precise arrangements and instrumentalities shown.

FIG. 1 is a cross-sectional illustration of a glass laminate structure according to some embodiments.

FIGS. 2A-2C illustrate a vacuum ring laminating process according to some embodiments.

FIG. 3 illustrates a vacuum bag laminating process according to some embodiments.

FIGS. 4A-4D illustrate four edge finishes for interlayer materials having a low and/or high modulus of rigidity.

FIGS. 5A and 5B are simplified plan views of some embodiments.

FIG. 5C is an experimental setup similar to the plan view of FIG. 5B.

FIG. 6A is a simplified cross section of a portion of an exemplary embodiment.

FIGS. 6B-6C are pictorial depictions of edge finishes of some embodiments.

FIG. 7A is a plan view of another embodiment.

FIG. 7B is a pictorial depiction of an exemplary rubber gasket.

FIGS. 7C-7D are pictorial depictions of an exemplary edge finish imparted to some embodiments using the rubber gasket of FIG. 7B.

FIG. 8 is a block diagram of an exemplary method according to some embodiments.

FIG. 9 is a block diagram of an exemplary method according to further embodiments.

FIG. 10 is a block diagram of any exemplary method according to some embodiments.

FIG. 11 is a graph comparing Young's Moduli for stiff, rigid interlayer materials and softer interlayer materials.

### DETAILED DESCRIPTION

In the following description, like reference characters designate like or corresponding parts throughout the several views shown in the figures. It is also understood that, unless otherwise specified, terms such as “top,” “bottom,” “outward,” “inward,” and the like are words of convenience and are not to be construed as limiting terms. In addition, whenever a group is described as comprising at least one of a group of elements and combinations thereof, it is understood that the group may comprise, consist essentially of, or consist of any number of those elements recited, either individually or in combination with each other.

Similarly, whenever a group is described as consisting of at least one of a group of elements or combinations thereof, it is understood that the group may consist of any number of those elements recited, either individually or in combination with each other. Unless otherwise specified, a range of values, when recited, includes both the upper and lower limits of the range. As used herein, the indefinite articles “a,” and “an,” and the corresponding definite article “the” mean “at least one” or “one or more,” unless otherwise specified.

The following description of the present disclosure is provided as an enabling teaching thereof and its best, currently-known embodiment. Those skilled in the art will recognize that many changes can be made to the embodiment described herein while still obtaining the beneficial results of the present disclosure. It will also be apparent that some of the desired benefits of the present disclosure can be obtained by selecting some of the features of the present disclosure without utilizing other features. Accordingly, those who work in the art will recognize that many modifications and adaptations of the present disclosure are possible and may even be desirable in certain circumstances and are part of the present disclosure. Thus, the following description is provided as illustrative of the principles of the present disclosure and not in limitation thereof.

Those skilled in the art will appreciate that many modifications to the exemplary embodiments described herein are possible without departing from the spirit and scope of the present disclosure. Thus, the description is not intended and should not be construed to be limited to the examples given but should be granted the full breadth of protection afforded by the appended claims and equivalents thereto. In addition, it is possible to use some of the features of the present disclosure without the corresponding use of other features. Accordingly, the following description of exemplary or illustrative embodiments is provided for the purpose of illustrating the principles of the present disclosure and not in limitation thereof and may include modification thereto and permutations thereof.

Glass lamination processes for the architectural, building, transport and automotive industries generally involves sandwiching one or more panes of glass with one or more films of plastic interlayers. These layers are then heated and pressurized to form a strong, heat-resistant, high-tensile-strength unit (i.e., a laminate structure) that may be tinted, sound-dampened, fire-resistant, and/or may be used as a filter for harmful ultraviolet light.

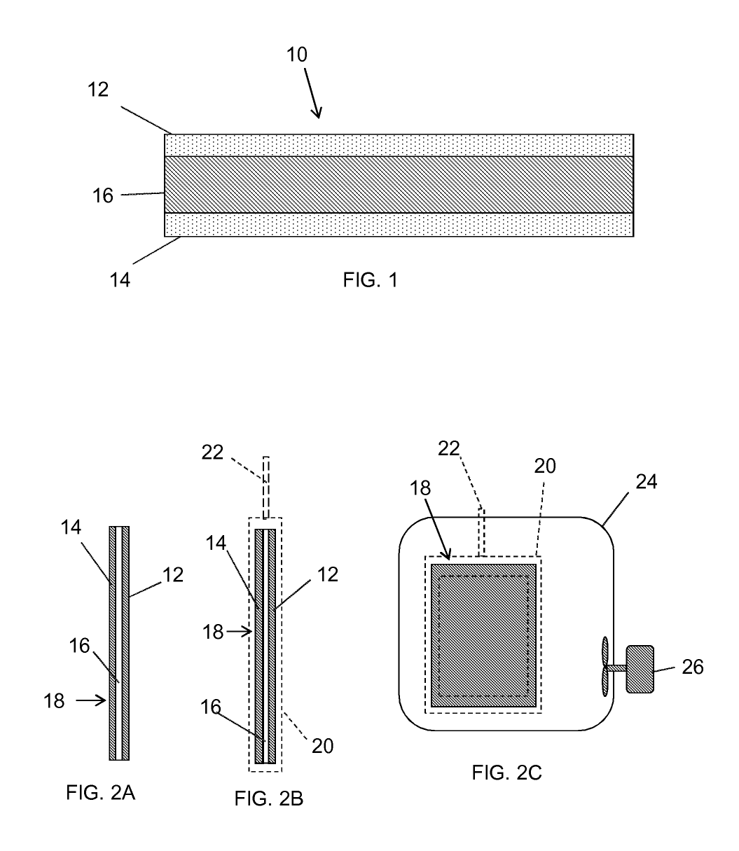

FIG. 1 is a cross-sectional illustration of a glass laminate structure 10 according to some embodiments. The glass laminate structure 10 may include two thin glass sheets 12 and 14 laminated one on either side of an intermediate polymeric interlayer 16. Alternatively, the glass laminate structure may include a first thin glass sheet and a second glass sheet having a thickness greater than the first thin glass sheet. The polymer interlayer 16 may be, but is not limited to, standard PVB, acoustic PVB, ethylene vinyl acetate (EVA), thermoplastic polyurethane (TPU), SentryGlas® (SG), an ionomer, or another suitable polymer or thermoplastic material having varying moduli of rigidity. Exemplary ionomer or ionoplast interlayer include interlayers having a Young's modulus greater than 100 MPa at temperatures up to 50° C. According to some embodiments, one or both of the glass sheets may be formed of thin glass sheets that have been chemically strengthened using an ion exchange process, such as Corning® Gorilla® glass from Corning Incorporated. In an ion exchange process, the glass sheets are typically immersed in a molten salt bath for a predetermined period of time. Ions within the glass sheet at or near the surface of the glass sheet are exchanged for larger metal ions, for example, from the salt bath. In a non-limiting embodiment, the temperature of the molten salt bath is about 430° C. and the predetermined time period is about eight hours. The incorporation of the larger ions into the glass strengthens the sheet by creating a compressive stress in a near surface region. A corresponding tensile stress is induced within a central region of the glass sheet to balance the compressive stress. Additional glasses may also be used including soda lime glass, Willow® glass, etc.

The term “thin” as used in relation to the glass sheets in the present disclosure and the appended claims means glass sheets having a thickness not exceeding about 2.0 mm, not exceeding about 1.5 mm, not exceeding about 1.0 mm, not exceeding about 0.7 mm, not exceeding about 0.5 mm, or within a range from about 0.1 mm to about 2.0 mm, from about 0.1 mm to about 1.5 mm, from about 0.1 mm to about 1.0 mm, or from about 0.1 mm to about 0.7 mm. The thermoplastic or polymeric layer can, in certain embodiments, have a thickness of at least 0.125 mm (e.g., 0.125, 0.25, 0.375, 0.5, 0.76, 0.81, 1.14 or 1.52 mm).

As described in U.S. Pat. Nos. 7,666,511, 4,483,700 and 5,674,790, Corning® Gorilla® glass can be made by fusion drawing a glass sheet and then chemical strengthening the glass sheet. Corning® Gorilla® glass has a relatively deep depth of layer (DOL) of compressive stress, and presents surfaces having a relatively high flexural strength, scratch resistance and impact resistance. The glass sheets 12 and 14 and the polymer interlayer 16 may be bonded together during a lamination process according to the present disclosure in which the glass sheet 12, interlayer 16 and glass sheet 14 are stacked one on top of the other, and heated to a temperature at or somewhat above the softening temperature of the polymer interlayer 16, such that the interlayer is adhered to the glass sheets.

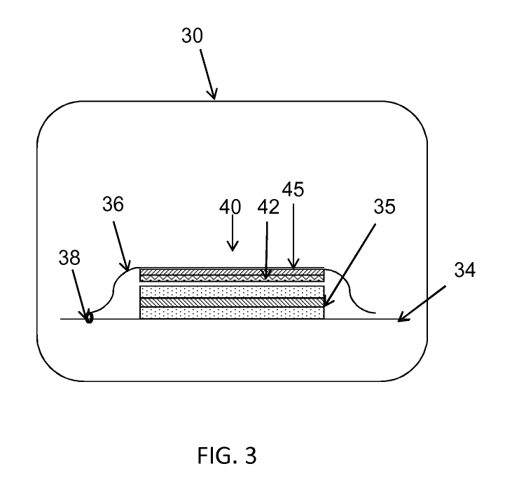

A vacuum ring laminating process according to some embodiments is schematically illustrated in FIGS. 2A through 2C. As shown in FIG. 2A, an exemplary vacuum ring laminating process may include assembling two thin glass sheets 12 and 14 and polymer interlayer 16 into a stack or assembly 18 by placing the interlayer 16 on a first glass sheet 12 and then placing a second glass sheet 14 on the interlayer 16. A vacuum ring 20, 22 may be clamped around the peripheral edge portion of the assembled stack 18 as shown in FIGS. 2B and 2C to form a seal for applying a vacuum to one or more peripheral edges (or portions thereof) of the assembled stack 18. While the figure depicts applying the vacuum to each peripheral edge of the assembled stack 18, the claims appended herewith should not be so limited as the vacuum can be applied to a single edge or even small portions of a single edge of an assembled stack 18. The assembled stack 18, as clamped in the vacuum ring 20, may then be placed into an autoclave or oven 24. A vacuum may be drawn in the vacuum ring 20 via a vacuum line/tube 22 on the vacuum ring and the temperature in the autoclave elevated to a temperature that is at or somewhat above the softening temperature of the polymer interlayer 16 (e.g., a soak temperature). The vacuum and soak temperature may be maintained to soften the interlayer 16, de-air the space between the two glass sheets 12 and 14, and bond/tack the softened interlayer 16 to the two glass sheets 12, 14, thereby laminating the assembled stack 18 together. The assembled stack may then be removed from the autoclave and the vacuum ring removed and separated from the stack. If necessary, the laminate structure may then be subsequently autoclaved at an elevated temperature and pressure to complete and/or clarify the glass laminate structure.

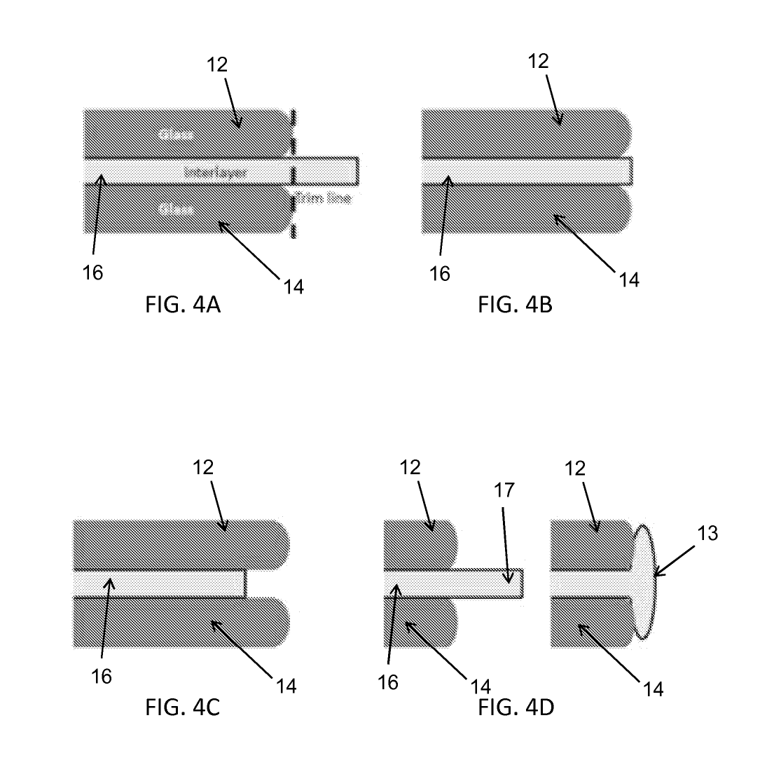

A vacuum bag laminating process according to some embodiments is schematically illustrated in FIG. 3. With reference to FIG. 3, a conventional autoclave 30 is illustrated in schematic form. As noted above, the autoclave 30 can be used to apply heat and/or pressure to form a unitary laminate structure from multiple layers of glass and polymeric materials. In some embodiments, a processing assembly 40, including a suitable working surface 34, can be placed in the autoclave 30. The assembly 40 can include sheets of glass with an intermediate interlayer that are stacked on, in some embodiments, the working surface 34 or held together with an affixing material to form an assembled stack 35. In its original form, the assembled stack 35 has an unconsolidated thickness that is substantially greater than the final thickness of the laminate structure after processing. While the working surface 34 is illustrated in FIG. 3 as being planar, it should be understood that the contour of the working surface can be curved or three-dimensional to form complex shapes. The processing assembly 40 can include an air-impermeable sheet 36 of conventional design that covers the entire assembled stack 35. In some embodiments, the air-impermeable sheet 36 can be replaced by an air-impermeable bag 36 substantially enclosing the assembled stack 35. In some embodiments, the air-impermeable sheet 36 can be sealed at its edges around the assembled stack 35 by a conventional edge seal 38. The air-impermeable sheet or bag 36 and/or working surface 34 can thus form an airtight vacuum bag.

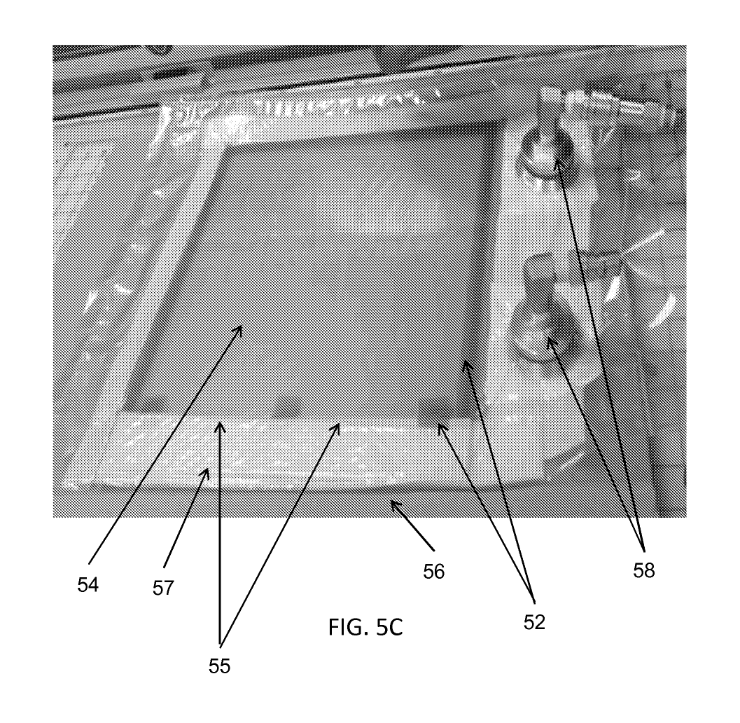

A vacuum pump (not shown) can be connected to one or more vacuum ports (see FIG. 5C) of the bag or to the working surface to evacuate the vacuum bag prior to or during the autoclaving process. When the vacuum bag is evacuated and the autoclave 30 is pressurized, the pressure differential between the inside and the outside of the vacuum bag causes the air-impermeable sheet or bag 36 to apply a compressive force to the top and sides of the laminate structure. Evacuating the vacuum bag prior to placing the processing assembly 40 in the autoclave holds the separate sheets in the assembled stack 35 in position as the processing assembly 40 is placed in the autoclave 30. Removing the air from the vacuum bag prior to placing the assembly 40 in the autoclave can lessen the volume of air that the autoclave 30 must force out of the bag during processing. Thus, in some embodiments, it can be desirable to evacuate the vacuum bag prior to the autoclaving process. Of course, the process can be performed without previously evacuating the vacuum bag as long as the vacuum bag is vented to atmosphere when the autoclave is pressurized.

In some embodiments, the processing assembly 40 can include an air-permeable breather cloth 45 to cover the assembled stack 35. The breather cloth 45 allows the air to flow more easily beneath the air-impermeable sheet 36 to facilitate the quick and even evacuation of the vacuum bag. An air-permeable release film 42 can be positioned between the breather cloth 45 and the assembled stack 35 in some embodiments. Exemplary release films 42 include a chemically inert material, such as but not limited to Teflon®, to prevent the breather cloth 45 from sticking to the assembled stack 35 at the end of the autoclaving process. Both the release film or cloth 42 and the breather cloth 45 should be fabricated of a material capable of withstanding high temperatures of an exemplary autoclaving process.

The autoclave described above can include a conventional heater (not shown) for heating the laminate structure as it is compressed when the vacuum bag is evacuated and the autoclave is pressurized. At the start of a non-limiting processing cycle, the vacuum bag can be evacuated and the laminate structure gradually heated until its temperature has increased to a predetermined temperature, e.g., soak temperature. Exemplary soak temperatures include, but are not limited to, between about 90° C. to about 150° C., between about 90° C. to about 120° C., between about 90° C. to about 100° C., and all sub-ranges therebetween. In other embodiments, the predetermined temperature is a function of the softening temperature of a respective interlayer material in the laminate structure, e.g., at least 5° C. or 10° C. above the softening temperature to promote bonding of the thermoplastic or polymeric material to the glass. When the temperature of the laminate structure reaches the predetermined temperature, the autoclave can be pressurized to a predetermined pressure to thereby apply a compressive force to the top and the edges of the laminate structure. Exemplary pressures include, but are not limited to, between about 80 psi to about 200 psi, between about 140 to about 180 psi, between about 80 psi to about 100 psi, and all sub-ranges therebetween. Once the autoclave is pressurized, the vacuum bag can be vented to atmosphere, although the vacuum can also be maintained during the autoclaving process. The temperature and pressures can be maintained for a predetermined period, e.g., soak time. Exemplary soak times include, but are not limited to, between about 30 minutes to about 120 minutes, between about 60 minutes to about 90 minutes, between about 45 minutes to about 60 minutes, and all sub-ranges therebetween. After this predetermined period, the laminate structure is allowed to gradually cool, the autoclave depressurized, and if the vacuum bag has not already been vented, it can be vented at this time. The air-impermeable sheet or bag, breather cloth and/or release film can then be removed from the laminate structure, and the post processed laminate structure removed from the working surface, if used.

The pliable nature of embodiments using thin glass sheets can allow for a lower soak temperature and a lower vacuum pressure as compared to typical vacuum ring and vacuum bag laminating processes. In some embodiments, thin glass sheets may be laminated in vacuum ring or a vacuum bag process at atmospheric pressure and at a de-air and tack temperature (or soak temperature) not exceeding about 150° C., not exceeding about 120° C., not exceeding about 100° C., in arrange of from about 90° C. to about 120° C., or from about 90° C. to about 100° C. in the autoclave or oven, while applying a vacuum to the peripheral edge of the assembled stack (via the vacuum ring or a vacuum bag) not exceeding about −0.9 bar, not exceeding about −0.6 bar, not exceeding about −0.5 bar, not exceeding about −0.3 bar, or within a range from about −0.2 to about −0.6 bar.

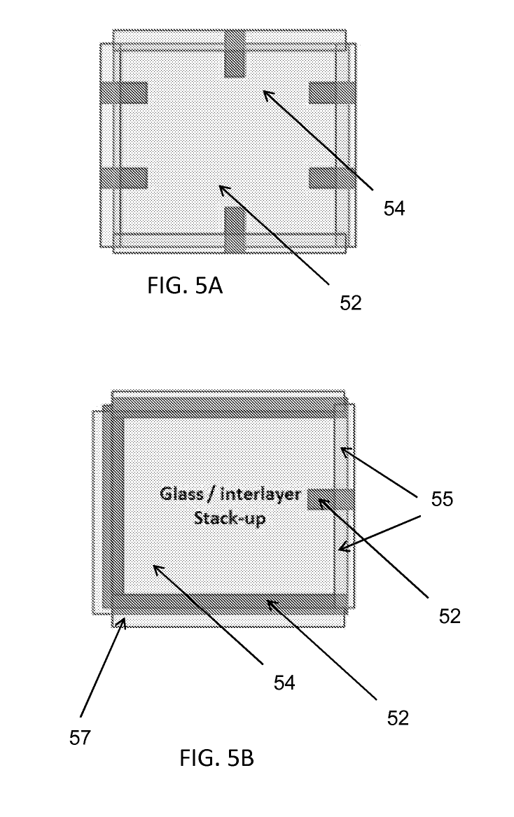

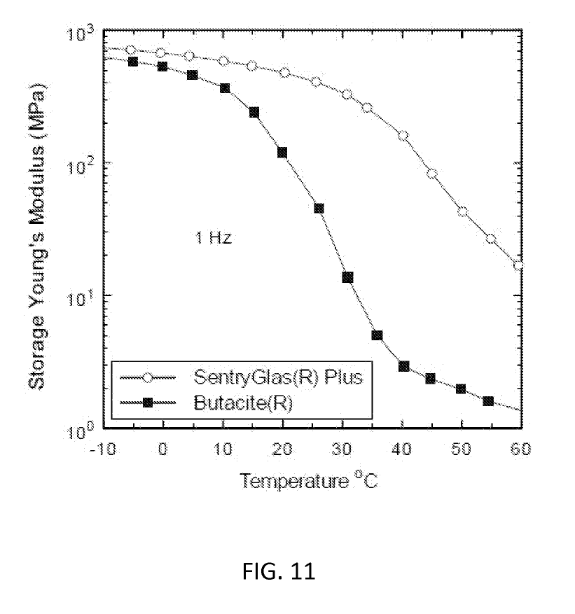

FIGS. 4A-4D illustrate four edge finishes for interlayer materials having a low modulus of rigidity. FIG. 11 is a graph comparing Young's Moduli for stiff, rigid interlayer materials and softer interlayer materials. Exemplary interlayer materials having a low modulus of rigidity or Young's Modulus include, but are not limited to, PVB, acoustic PVR, Butacite, and the like. With reference to FIG. 11, exemplary Young's Moduli for these softer interlayer materials range are less than about 10 MPa at temperatures between about 30-60° C. With reference to FIGS. 4A-4D, the interlayer material 16 may be overcut and trimmed (FIG. 4A), cut to the size of the adjacent sheets of glass 12, 14 (FIG. 4B), under cut to the size of the adjacent sheets of glass 12, 14 (FIG. 4C), or overcut to the size of the adjacent sheets of glass 12, 14 and pressed (FIG. 4D). With reference to FIG. 4A, an exemplary interlayer 16 may be cut larger than the adjacent sheets of glass 12, 14 and then trimmed with a sharp implement to size thus providing a trim-to-size edge. With reference to FIG. 4B, an exemplary interlayer 16 may be cut to substantially the same size of the adjacent sheets of glass 12, 14 with a resultant edge finish similar to the edge finish in FIG. 4B but without requiring a post-autoclave edge trimming process. Such a process, however, can result in edge misalignment or under/over-cut errors from the sizing of the interlayer 16. With reference to FIG. 4C, the interlayer 16 can be cut smaller than the adjacent sheets of glass 12, 14 thus hiding under/over cut errors and minimizing misalignment errors. With reference to FIG. 4D, the edge of the glass sheets having a finish tends to protect the glass edge owing to an extension 17 of the interlayer 16 beyond the glass. Utilizing a compressive gasket or a hot-knife pressure cut after an exemplary autoclave process can result in a pressed edge profile 13 providing additional enhanced glass edge protection.

Edge finishes for the stiffer or more rigid interlayer glass to glass laminate structures can also be addressed using four different methods. Exemplary interlayer materials having a high modulus of rigidity or Young's Modulus include, but are not limited to, SentryGlas, and the like. Exemplary Young's Moduli for these stiffer interlayer materials range from over 100 MPa at 30° C. to about 100 MPa at about 50° C. With continued reference to FIGS. 4A-4D, the interlayer material 16 may be cut to the size of the adjacent sheets of glass 12, 14 (FIG. 4B), under cut to the size of the adjacent sheets of glass 12, 14 (FIG. 4C), overcut and trimmed (FIG. 4A), or ground and polished (not shown). With reference to FIGS. 4B and 4C, these methods can result in an edge with no additional post-autoclave work, while the method depicted in FIG. 4A and the grinding/polishing method may require post-autoclave processes including the utilization of a hot-knife edge cut (FIG. 4A) and an additional grind/polish process.

In embodiments having a stiff, rigid, and/or hard-to-cut interlayer material (high modulus of rigidity) conventionally it can be difficult to provide a custom finish that protects the edge of an exemplary glass laminate structure. In some embodiments, the glass being utilized with the structure can be either thermally or chemically tempered and thus, no edge grinding or polishing would be allowed due to resultant weakening or fracturing of and crack propagation in the glass material. An exemplary method according to the present disclosure, however, would provide an autoclave binding process which can alter the position and/or materials of the layers used in an autoclave vacuum bag or ring with a change in vacuum extraction from the assembly. The resultant edge finish on the laminated structure would not surround the structure completely, e.g., for a square or rectangular structure three edges would be finished and portions of the fourth edge would be unfinished owing to the requirement for vacuum extraction.

In such an exemplary embodiment, the glass and interlayer assembly for autoclave lamination can be held in position with flash tape or another suitable affixing material such as, but not limited to, a compressive rubber gasket, a compressive polymeric gasket, or any binder that can handle the temperature excursions and provide a compression by either providing a compression from its construction or allows it to collapse and provide the compression from the vacuum extraction and the like, and then wrapped in a release film or cloth and breather cloth prior to insertion into a vacuum bag or ring. Flash tape or another suitable affixing material can be used to maintain the positioning of the assembly and in some embodiments, the flash tape or other suitable affixing material can also be used to contribute to the finish of the edge. FIGS. 5A and 5B are simplified plan views of some embodiments. FIG. 5C is an experimental setup similar to the plan view of FIG. 5B. With reference to FIG. 5A, an exemplary affixing material 52, flash tape in the depicted non-limiting example, can be used perpendicular to the glass and interlayer assembly 54 for maintaining the position of the layers within the assembly during autoclaving processes. With reference to FIGS. 5B and 5C, an exemplary affixing mechanism 52 can be used to both maintain the position of the layers in a glass and interlayer assembly and to provide edge texturing. In the depicted embodiment, some portion 55 of an edge of the assembly 54 would not be processed to allow for the evacuation of air in autoclaving process. By way of a non-limiting example, in a square laminate structure, an exemplary affixing mechanism 52 can be used to edge finish three of the four edges whereby a portion of the fourth edge is left unfinished which provides a path to evacuate the assembly 54. Any portion of the fourth edge can be left unfinished and the depicted examples in FIGS. 5B and 5C should not limit the scope of the claims appended herewith at least one small portion of the edge should be left open to provide an evacuation path. Thus, in some embodiments substantially all of the fourth edge can also include a finished edge. In the experimental depiction of FIG. 5C, vacuum ports 58 were positioned to the right of the air extraction side 56 to allow for a vertical mounting in a respective autoclave. Breather cloths 57 can be used in this embodiment to allow a connection to one or more vacuum ports 58 and to enable air extraction from all around the laminate. Of course, in some embodiments extraction from the interlayer only occurs on a single side 56 or from multiple but not all sides of an assembly. In some embodiments, vertical mounting of an exemplary assembly in an autoclave can allow non-contact autoclaving of the finished sides.

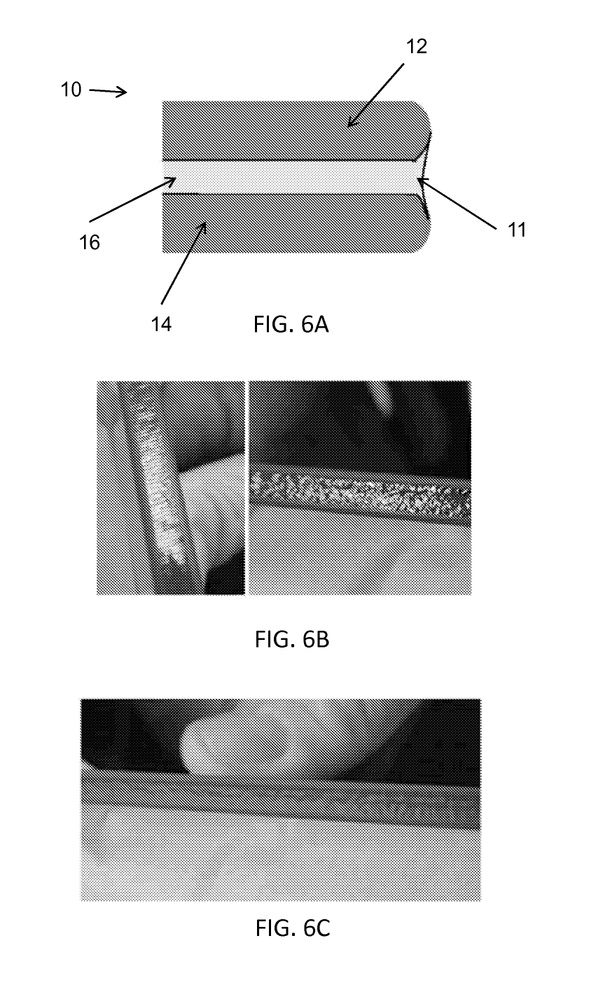

In additional embodiments, release films or cloths and breather cloths 57 can be utilized prior to enclosing the assembly in a vacuum ring or bag. The release film or cloth can be optional as its main function can be to contact the affixing mechanism parallel to the laminate structure edge and to provide edge texturing during a respective autoclave cycle. Thus, a release cloth layer can be eliminated or substituted with a different cloth to provide different edge textures in some embodiments. In further embodiments, the finish on the actual affixing material and any backing texturing material (such as the release cloth) can control the final edge finish profile and luster of a processed glass laminate structure. For example, if the affixing material, e.g., tape, gasket, etc., has a matte finish then this finish on the affixing material would control the luster of the finished laminated edge while any backside textured material (such as release cloth) would control the final edge texture as illustrated in FIGS. 6A-6C. FIG. 6A is a simplified cross section of a portion of an exemplary embodiment. FIGS. 6B-6C are pictorial depictions of edge finishes of some embodiments. FIG. 6A illustrates a glass laminate structure 10 having two glass sheets 12, 14 and an intermediate polymeric interlayer 16 with a finished edge 11. FIGS. 6B and 6C illustrate different, non-limiting types of edge finishes that can be obtained with changing the texture or pattern of the affixing mechanism and/or breather cloth materials.

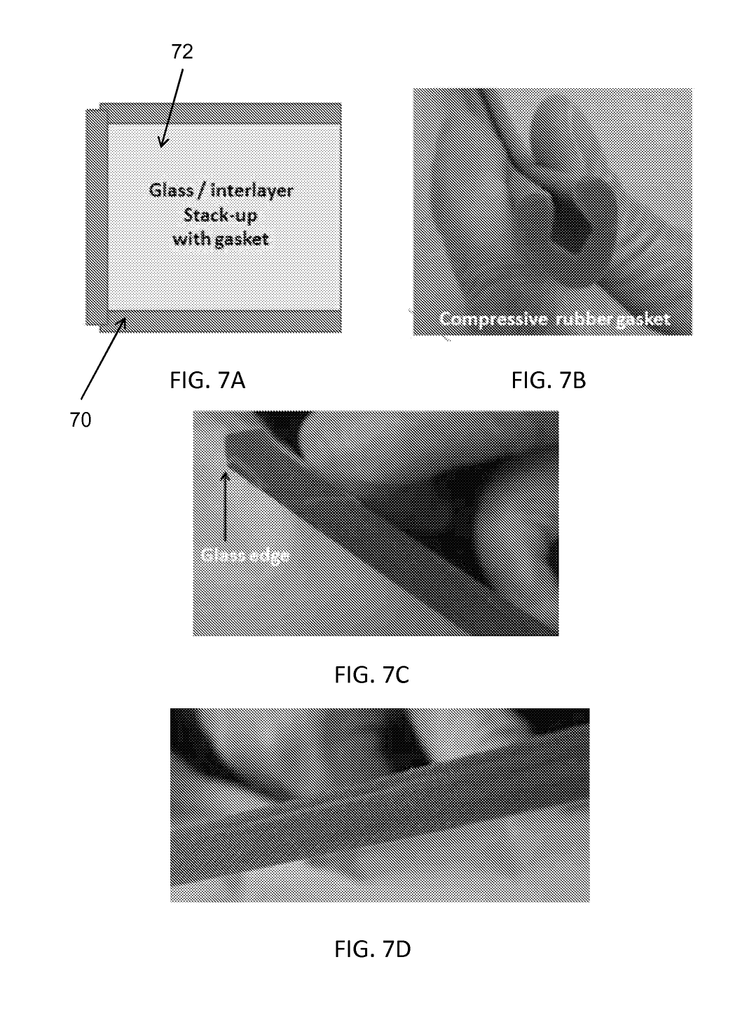

FIG. 7A is a plan view of another embodiment. FIG. 7B is a pictorial depiction of an exemplary rubber gasket. FIGS. 7C-7D are pictorial depictions of an exemplary edge finish imparted to some embodiments using the rubber gasket of FIG. 7B. With reference to FIGS. 7A-7D, a compressive perimeter rubber gasket 70 or other suitable gasket material can be placed over one or more edges of an exemplary laminate assembly 72 and placed in intimate contact with the edge of the laminate assembly 72. In some embodiments, the assembly can include a cut-to-size, over cut interlayer or other suitable interlayer depiction (see FIGS. 4A-4D). Such embodiments can thus provide any suitable or desired allow edge sculpturing to occur on a finished laminate structure. For example, as the interlayer material softens during a hot autoclave cycle, the compressive rubber gasket (or other suitable gasket material) can provide a mold for the new edge finish to adopt (FIGS. 7C and 7D). Thus, contour control can be obtained with the utilization of a compressive perimeter material along one or more edges of an exemplary glass laminate structure. Of course, the geometry of the perimeter material depicted in FIG. 7B is exemplary only and should not limit the scope of the claims appended herewith as any suitable geometry for a perimeter material can be used to provide a desired edge contour and/or finish. Utilizing the compressive perimeter material on overcut interlayer embodiments can thus provide a superior curve advantage for highly curved products as conventional taping cannot properly seal or tape three-dimensional or complex geometries. Exemplary compressive perimeter materials can also be re-usable, and the edge profiles that extend past the glass can be customized with the use of such a compressive material. Thus, exemplary edge profiles can be controlled by altering the internal mold or cross sectional shape of the compressive material.

Embodiments described herein can thus provide edge finish solutions to stiff, rigid, and hard to cut interlayers by providing a process that is in situ or simultaneous with an autoclave cycle. The edge finish would not be fully realized until the autoclave process is completed, and exemplary in-situ autoclave edge finishing can provide various edge finishes from dull, shiny finishes (FIGS. 6B-6C) to textured finishes and surfaces (FIGS. 6B, 6C, 7D). Of course, these finishes are exemplary only and should not limit the scope of the claims appended herewith as the finishes imparted to a glass laminate structure during an exemplary process can be any type of desired finish. Further, such exemplary finishes can be flush with the glass laminate structure, under cut to the glass or protruding from the glass adding further edge protection to the respective structure. Exemplary methods according to the present disclosure do not require any additional processing to obtain a finished edge on a glass laminate structure. Further, exemplary methods can be used for thermally or chemically tempered glasses and can be used in-situ an exemplary autoclave cycle. Such methods can provide textures from dull to shiny and from regular to random surface feature finishes as well as any suitable custom edge finish that a potential customer would desire. Furthermore, exemplary processes can alter the standard vacuum de-airing and continuous vacuum pull. For example, a square or rectangular assembly for an autoclave process would usually de-air and pull vacuum from all sides of the stack-up; however, exemplary methods according to the present disclosure would produce one or more finished edges by using predetermined edges (or portions thereof) for de-airing and pulling vacuum.

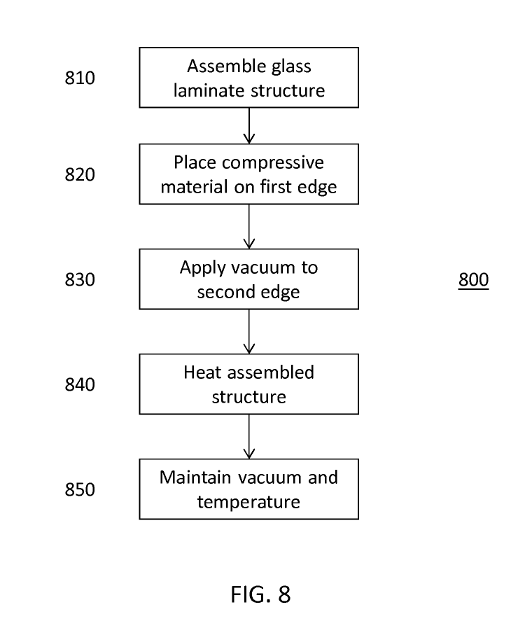

FIG. 8 is a block diagram of an exemplary method according to some embodiments. With reference to FIG. 8, a method 800 is provided for finishing an edge of a glass laminate structure. The method 800 includes assembling a glass laminate structure having a first glass sheet, a second glass sheet and an interlayer material intermediate the first and second glass sheets at step 810 and placing a compressive material on a first edge of the assembled structure at step 820. Exemplary polymer interlayers can be, but are not limited to, PVB, acoustic PVB, ethylene vinyl acetate (EVA), thermoplastic polyurethane (TPU), SentryGlas (SG), an ionomer, and combinations thereof. These interlayer materials can have a modulus of rigidity of as shown in FIG. 11, e.g., from over 100 MPa at 30° C. to about 100 MPa at about 50° C. The first glass sheet can have a thickness not exceeding about 2.0 mm, not exceeding about 1.5 mm, not exceeding about 1.0 mm, not exceeding about 0.7 mm, not exceeding about 0.5 mm, or within a range from about 0.1 mm to about 2.0 mm, within a range from about 0.1 mm to about 1.5 mm, from about 0.1 mm to about 1.0 mm, or from about 0.1 mm to about 0.7 mm. In some embodiments, the thickness of the first and second glass sheets can be different. In another embodiment, the interlayer material can have a thickness of at least 0.125 mm. In other embodiments, step 820 can include placing a compressive gasket around substantially all the first edge, a third edge and a fourth edge of the assembled structure. Step 820 can also include placing a compressive gasket around a portion of the second edge of the assembled structure. In yet another embodiment, step 820 can include attaching material longitudinally to the first edge, attaching material perpendicularly to a portion of the second edge, and placing breathing cloth on the first and second edges. In additional embodiments, the longitudinally attached material can be, but is not limited to, flash tape, a compressive gasket, and any binder that can handle the temperature excursions and provide a compression by either providing a compression from its construction or allows it to collapse and provide the compression from the vacuum extraction and combinations thereof. In some embodiments, step 820 can include placing release cloth on the assembled structure intermediate the breathing cloth and assembled structure.

At step 830, a vacuum can be applied to a second edge of the assembled structure, and at step 840 the assembled structure can be heated to a predetermined temperature at or above a softening temperature of the interlayer material. In further embodiments, step 830 can include placing the assembled structure into a vacuum bag. At step 850, the vacuum and temperature can be maintained for a predetermined period of time whereby the compressive material provides an in situ finish for the first edge of the glass laminate structure. In some embodiments, the assembled structure is non-planar. In other embodiments, one or more edges of the assembled structure can be curved in two or three dimensions. In some embodiments, the vacuum can be maintained at a level not exceeding about −0.9 bar, not exceeding about −0.6 bar, not exceeding about −0.5 bar, or within a range from about −0.5 to about −0.9 bar for the full autoclave cycle, up to the full soak time, up to 75% of the soak time, up to 50% of the soak time, up to 25% of the soak time, or any intermediate portion of the soak time. In other embodiments, the temperature can be maintained at between about 90° C. to about 150° C., between about 90° C. to about 120° C., between about 90° C. to about 100° C., and all sub-ranges therebetween for between about 30 minutes to about 120 minutes, between about 60 minutes to about 90 minutes, between about 45 minutes to about 60 minutes, and all sub-ranges therebetween.

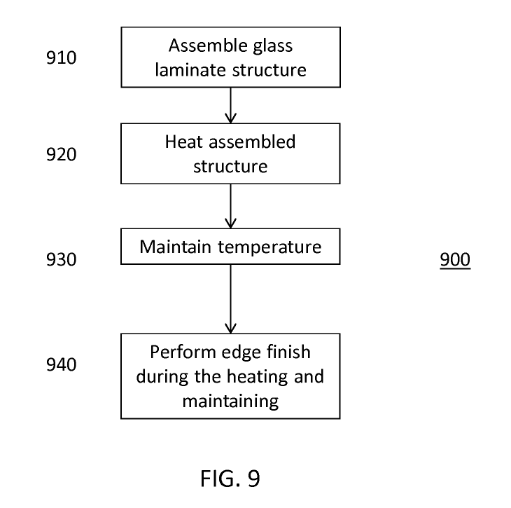

FIG. 9 is a block diagram of an exemplary method according to further embodiments. With reference to FIG. 9, a method 900 is provided for finishing an edge of a glass laminate structure. The method 900 includes assembling a glass laminate structure having a first glass sheet, a second glass sheet and an interlayer material intermediate the first and second glass sheets in step 910 and heating the assembled structure in an autoclave at a temperature at or above a softening temperature of the interlayer material in step 920. In step 930, the temperature is maintained for a predetermined period of time and at step 940 an edge finish is performed to one or more edges of the assembled structure during the steps of heating and maintaining.

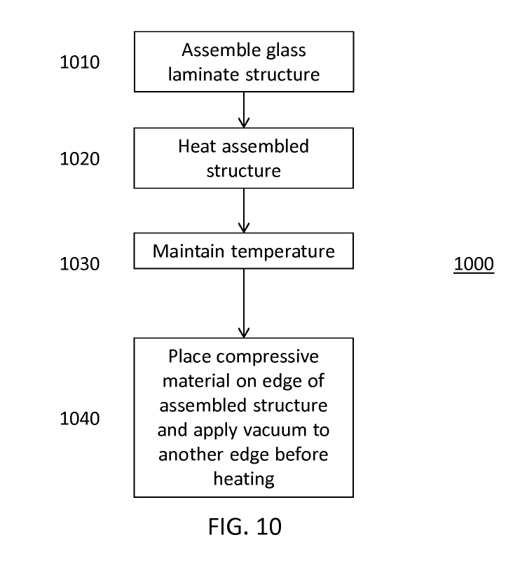

FIG. 10 is a block diagram of any exemplary method according to some embodiments. With reference to FIG. 10, a method 1000 is provided for edge finishing a glass laminate structure comprising the steps of providing a glass laminate structure having a first glass sheet, a second glass sheet and an interlayer material intermediate the first and second glass sheets in step 1010, heating the assembled structure in an autoclave at a temperature at or above a softening temperature of the interlayer material in step 1020, and maintaining the temperature for a predetermined period of time in step 1030. The method 1000 also includes the step of providing an edge finish to one or more edges of the assembled structure without cooling the autoclave in step 1040. In some embodiments, step 1040 includes placing a compressive material on at least one edge of the assembled structure and applying a vacuum to another edge of the assembled structure before heating the assembled structure.

While this description may include many specifics, these should not be construed as limitations on the scope thereof, but rather as descriptions of features that may be specific to particular embodiments. Certain features that have been heretofore described in the context of separate embodiments may also be implemented in combination in a single embodiment. Conversely, various features that are described in the context of a single embodiment may also be implemented in multiple embodiments separately or in any suitable subcombination. Moreover, although features may be described above as acting in certain combinations and may even be initially claimed as such, one or more features from a claimed combination may in some cases be excised from the combination, and the claimed combination may be directed to a subcombination or variation of a subcombination.

Similarly, while operations are depicted in the drawings or figures in a particular order, this should not be understood as requiring that such operations be performed in the particular order shown or in sequential order, or that all illustrated operations be performed, to achieve desirable results. In certain circumstances, multitasking and parallel processing may be advantageous

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

It is also noted that recitations herein refer to a component of the present disclosure being “configured” or “adapted to” function in a particular way. In this respect, such a component is “configured” or “adapted to” embody a particular property, or function in a particular manner, where such recitations are structural recitations as opposed to recitations of intended use. More specifically, the references herein to the manner in which a component is “configured” or “adapted to” denotes an existing physical condition of the component and, as such, is to be taken as a definite recitation of the structural characteristics of the component.

As shown by the various configurations and embodiments illustrated in the figures, various methods for laminating thin glass structures have been described.

While preferred embodiments of the present disclosure have been described, it is to be understood that the embodiments described are illustrative only and that the scope of the invention is to be defined solely by the appended claims when accorded a full range of equivalence, many variations and modifications naturally occurring to those of skill in the art from a perusal hereof.

1. A method for finishing an edge of a glass laminate structure comprising the steps of:
assembling a glass laminate structure having a first glass sheet, a second glass sheet and an interlayer material intermediate the first and second glass sheets;
placing a compressive material on a first edge of the assembled structure;
applying a vacuum to a second edge of the assembled structure;
heating the assembled structure to a predetermined temperature at or above a softening temperature of the interlayer material;
maintaining the vacuum and temperature for a predetermined period of time,
wherein the compressive material provides an in situ finish for the first edge of the glass laminate structure.

2. The method of claim 1, wherein, the polymer interlayer is selected from the group consisting of polyvinyl butyral, acoustic PVB, ethylene vinyl acetate (EVA), thermoplastic polyurethane (TPU), SentryGlas (SG), an ionomer, and combinations thereof.

3. The method of claim 1, wherein the interlayer material has a modulus of rigidity of greater than about 100 MPa at 30° C. to about 100 MPa at about 50° C.

4. The method of claim 1, wherein the first glass sheet has a thickness not exceeding about 2.0 mm, not exceeding about 1.5 mm, not exceeding about 1.0 mm, not exceeding about 0.7 mm, not exceeding about 0.5 mm, or within a range from about 0.1 mm to about 2.0 mm, within a range from about 0.1 mm to about 1.5 mm, from about 0.1 mm to about 1.0 mm, or from about 0.1 mm to about 0.7 mm.

5. The method of claim 1, wherein the thickness of the first and second glass sheets are different.

6. The method of claim 1, wherein the interlayer material has a thickness of at least 0.125 mm.

7. The method of claim 1, wherein the step of placing a compressive material further comprises placing a compressive gasket around substantially all the first edge, a third edge and a fourth edge of the assembled structure.

8. The method of claim 7, wherein the step of placing a compressive material further comprises placing a compressive gasket around a portion of the second edge of the assembled structure.

9. The method of claim 1, wherein the step of placing a compressive material further comprises attaching material longitudinally to the first edge, attaching material perpendicularly to a portion of the second edge, and placing breathing cloth on the first and second edges.

10. The method of claim 9, wherein the longitudinally attached material is selected from the group consisting of flash tape, a compressive gasket, and combinations thereof.

11. The method of claim 9 wherein the step of placing further comprises placing release cloth on the assembled structure intermediate the breathing cloth and assembled structure.

12. The method of claim 1, wherein the assembled structure is non-planar.

13. The method of claim 1, wherein one or more edges of the assembled structure is curved in two or three dimensions.

14. The method of claim 1, wherein the step of applying a vacuum to a second edge of the assembled structure further comprises placing the assembled structure into a vacuum bag.

15. The method of claim 1, wherein the vacuum is maintained a level not exceeding about −0.9 bar, not exceeding about −0.6 bar, not exceeding about −0.5 bar, or within a range from about −0.5 to about −0.9 bar for a full autoclave cycle, up to a full soak time, up to 75% of the soak time, up to 50% of the soak time, up to 25% of the soak time, or any intermediate portion of the soak time.

16. The method of claim 1, wherein the temperature is maintained at between about 90° C. to about 150° C., between about 90° C. to about 120° C., between about 90° C. to about 100° C., and all sub-ranges therebetween, between about 30 minutes to about 120 minutes, between about 60 minutes to about 90 minutes, between about 45 minutes to about 60 minutes, and all sub-ranges therebetween.

17. A method for finishing an edge of a glass laminate structure comprising the steps of:
assembling a glass laminate structure having a first glass sheet, a second glass sheet and an interlayer material intermediate the first and second glass sheets;
heating the assembled structure in an autoclave at a temperature at or above a softening temperature of the interlayer material;
maintaining the temperature for a predetermined period of time and
performing an edge finish to one or more edges of the assembled structure during the steps of heating and maintaining.

18. A method of providing an edge finish to a glass laminate structure comprising: heating an assembled glass laminate structure in an autoclave at a temperature at or above a softening temperature of the interlayer material, wherein the assembled glass laminate structure comprises a first glass sheet, a second glass sheet and an interlayer material intermediate the first and second glass sheets; maintaining the temperature for a predetermined period of time; and providing an edge finish to one or more edges of the assembled structure without cooling the autoclave.

19. The method of claim 18 wherein providing an edge finish includes placing a compressive material on at least one edge of the assembled structure and applying a vacuum to another edge of the assembled structure before heating the assembled structure.

20. A glass laminate structure produced by any of the methods of claim 1.
